(19) United States
(12) Patent Application Publication
(10) Pub. No.: US 2023/0096216 A1
(43) Pub. Date: Mar. 30, 2023

(54) MOTOR

(71) Applicant: FANUC CORPORATION, Yamanashi (JP)

(72) Inventors: Shu HUANG, Yamanashi (JP); Daisuke HAYAHI, Yamanashi (JP)

(73) Assignee: FANUC CORPORATION, Yamanashi (JP)

(21) Appl. No.: 17/906,048

(22) PCT Filed: Mar. 19, 2021
(86) PCT No.: PCT/JP2021/011474

§ 371 Date: Sep. 9, 2022

(30) Foreign Application Priority Data
Mar. 25, 2020 (JP) 2020-053616

(51) Int. Cl. H02K 3/28

(52) U.S. Cl. CPC H02K 3/28

(57) ABSTRACT

Provided is a motor in which the interference between systems can be suppressed even when the number of pole pairs is odd. The motor according to one embodiment of the present disclosure is a three-phase AC motor provided with two-system stator windings to which voltages are applied by inverters different from each other and each of which has a plurality of coils, wherein said stator windings are ubiquitous in the circumferential direction so that the number of said coils disposed overlapped with said coils of the other system is reduced.

### TECHNICAL FIELD

The present invention relates to a motor.

### BACKGROUND ART

A double winding motor having two stator windings of different systems that receive power from different inverters has been known. In an existing double winding motor, coils of the two windings are arranged to overlap with each other or to be adjacent to each other in the whole circumferential direction of the stator. In this case, magnetic fluxes produced by the two windings interfere with each other. This may disadvantageously cause vibration if a phase difference between the two inverters increases. Thus, it is difficult for the existing double winding motor to achieve high gain (input power at acceleration and deceleration) and improve control response.

Patent Document 1 discloses a multi-winding AC motor aimed to block failure of the inverter in one of the systems from affecting the inverter in the other system via a magnetic bond between the windings. According to Patent Document 1, coils forming wiring groups are wound by a concentrated wiring method. Suppose the greatest common divisor of a pole count and slot count of the AC motor is m, the number of the wiring groups is n, and the minimum value of a divisor m/n excluding one is M, the number of portions of the wiring groups adjacent to each other is n×M so that the number is minimized in the circumferential direction, and the coils of the same phase of the wiring groups are arranged at angular positions equally mechanically divided in the circumferential direction.
Patent Document 1: Japanese Patent No. 5021247

### DISCLOSURE OF THE INVENTION

### Problems to be Solved by the Invention

In the motor of Patent Document 1, the coils are separately arranged for each system to reduce the magnetic bond between the windings. Specifically, in the motor of Patent Document 1, one of the stator windings reacts on half of the poles of a rotor, and the other stator winding reacts on the other half of the poles of the rotor. In such a motor, it is required that the two stator windings are electrically equivalent and the three phases of each stator winding are symmetric. Thus, the pole count of the motor of Patent Document 1 is required to be a multiple of four (the number of pole pairs needs to be even) so that the stator windings have an equal number of coils. In general, a motor having an odd number of pole pairs is widely used. However, when the number of pole pairs is odd, the stator windings cannot be divided into two systems to meet the above requirement. Thus, the configuration of Patent Document 1 cannot be applied to the motor having an odd number of pole pairs. Under these circumstances, it is desired to provide a motor that can reduce interference between the systems by reducing overlap of the two stator windings even when the number of pole pairs is odd.

### Means for Solving the Problems

A motor according to an embodiment of the present disclosure is a three-phase AC motor. The motor includes: two stator windings of different systems that receive voltages applied from different inverters, each of the stator windings having a plurality of coils. The stator windings are unevenly distributed in a circumferential direction to reduce the number of coils of one of the stator windings overlapping with the coils of the other stator winding.

### Effects of the Invention

The motor according to the embodiment of the present disclosure can reduce interference between the systems when the number of pole pairs is odd.

### BRIEF DESCRIPTION OF THE DRAWINGS

FIG. 1 is a schematic view illustrating a configuration of a drive system including a motor according to a first embodiment of the present disclosure;

FIG. 2 is a schematic view illustrating a configuration of the motor of the drive system of FIG. 1;

FIG. 3 is a schematic development illustrating a configuration of a first phase of stator windings of the motor of FIG. 2;

FIG. 4 is a wiring diagram illustrating a configuration of a second phase of the stator windings of the motor of FIG. 2;

FIG. 5 is a wiring diagram illustrating a configuration of a third phase of the stator windings of the motor of FIG. 2;

FIG. 6 is a schematic view illustrating a configuration of a motor according to a second embodiment of the present disclosure;

FIG. 7 is a wiring diagram illustrating a configuration of a first phase of stator windings of the motor of FIG. 4;

FIG. 8 is a wiring diagram illustrating a configuration of a second phase of the stator windings of the motor of FIG. 4; and

FIG. 9 is a wiring diagram illustrating a configuration of a third phase of the stator windings of the motor of FIG. 4.

### PREFERRED MODE FOR CARRYING OUT THE INVENTION

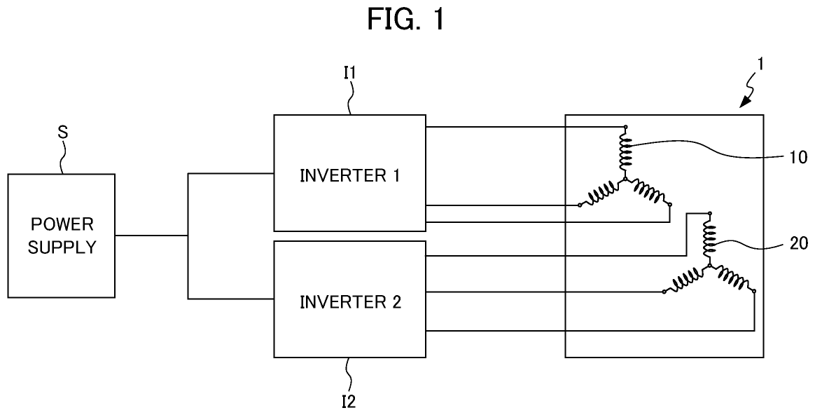

Embodiments of the present disclosure will be described below with reference to the drawings. FIG. 1 shows a configuration of a drive system including a motor 1 according to a first embodiment of the present disclosure.

The drive system of FIG. 1 includes an AC power supply S, two inverters I1 and I2 each independently converting a current supplied from the AC power supply S to a three-phase alternating current of any frequency, and the motor 1 that receives three-phase alternating voltages from the inverters I1 and I2. The motor 1 is a three-phase AC motor, and includes two stator windings of different systems (a first stator winding 10 and a second stator winding 20) that receive the three-phase alternating voltages applied from the different inverters I1 and I2.

The motor 1 further includes a rotor (not shown) that is rotated by a rotating magnetic field produced by the first stator winding 10 and the second stator winding 20. The motor 1 of the present embodiment has six poles, i.e., has an odd number of pole pairs (three pole pairs).

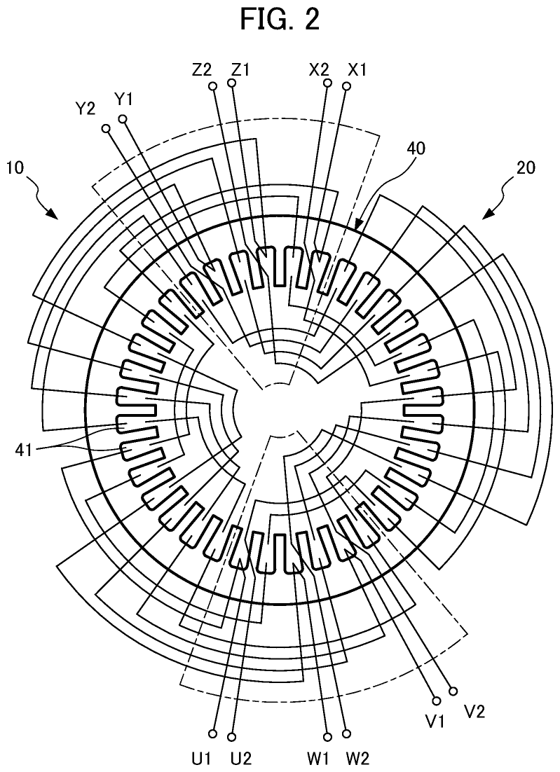

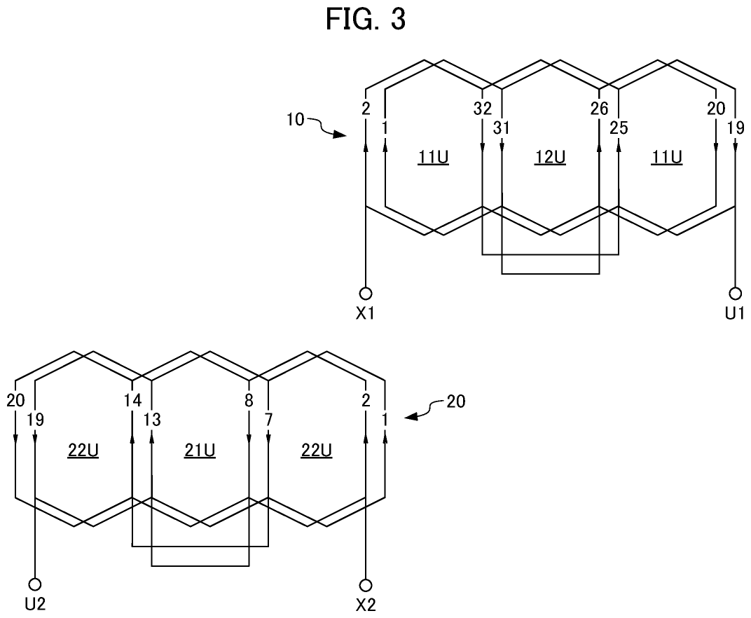

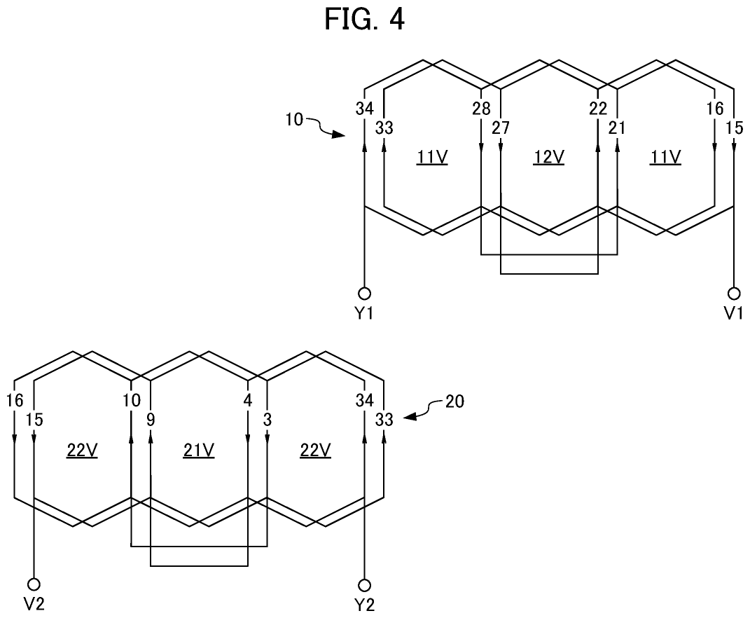

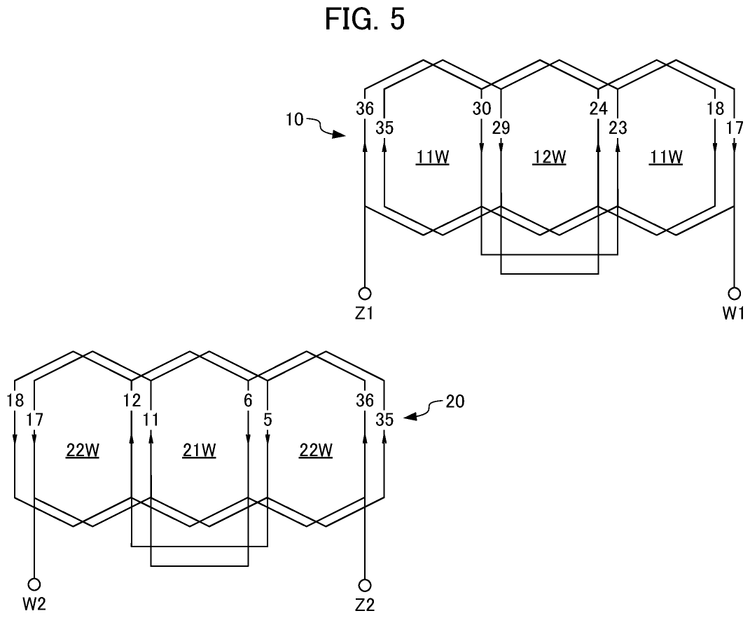

The stator windings 10 and 20 of the motor 1 will be described in detail below. FIG. 2 is a schematic view illustrating the stator windings of the motor 1. FIG. 3 is a schematic development illustrating a configuration of a first phase of the stator windings 10 and 20 of the motor 1. FIG. 4 is a wiring diagram illustrating a configuration of a second phase of the stator windings 10 and 20 of the motor 1. FIG. 5 is a wiring diagram illustrating a configuration of a third phase of the stator windings 10 and 20 of the motor 1.

The motor 1 includes external terminals U1, V1, and W1 for applying the three-phase alternating voltage to the first stator winding 10 from the first inverter I1, internal terminals X1, Y1, and Z1 for star connection or delta connection of the first stator winding 10, external terminals U2, V2, and W2 for applying the three-phase alternating voltage to the second stator winding 20 from the second inverter 12, and internal terminals X2, Y2, and Z2 for star connection or delta connection of the second stator winding 20.

Each of the first and second stator windings 10 and 20 has a plurality of right-handed coils and a plurality of left-handed coils that are alternately arranged. The first stator winding 10 has a plurality of right-handed coils 11 and a plurality of left-handed coils 12, and the second stator winding 20 has a plurality of right-handed coils 21 and a plurality of left-handed coils 22. The right-handed coils 11 and 21 are wound to produce the N pole on the rotor side when a positive voltage is applied to the terminals, and the left-handed coils 12 and 22 are wound in a reverse direction. When it is necessary to specify the phase of the voltage applied to each of the coils 11, 12, 21, and 22, an alphabetic character “U”, “V”, or “W” indicating the phase may be added to the reference numeral.

More specifically, the first stator winding 10 has two right-handed coils 11 for each phase, i.e., six in total, and one left-handed coil 12 for each phase, i.e., three in total.

The second stator winding 20 has one right-handed coil 21 for each phase, i.e., three in total, and two left-handed coils 22 for each phase, i.e., six in total. That is, the first stator winding 10 has three more right-handed coils 11 than the left-handed coils 12, and the second stator winding 20 has three less right-handed coils 21 than the left-handed coils 22. The total number of the right-handed coils 11 and 21 is equal to the total number of the left-handed coils 12 and 22.

In the first stator winding 10, the center of the third-phase left-handed coil 12W is located between the center of the first-phase right-handed coil 11U and the center of the second-phase right-handed coil 11V. In the second stator winding 20, the center of the third-phase left-handed coil 22W is located between the center of the first-phase right-handed coil 21U and the center of the second-phase right-handed coil 21V. The coils 11, 12, 21, and 22 are arranged in the motor 1 so that the U-phase right-handed coil 11U or 21U, the W-phase left-handed coil 12W or 22W, the V-phase right-handed coil 11V or 21V, the U-phase left-handed coil 12U or 22U, the W-phase right-handed coil 11W or 21W, and the V-phase left-handed coil 12V or 22V are repeatedly arranged in this order.

When the coils 11, 12, 21, and 22 are arranged to meet this requirement, the coils 11 and 12 of the first stator winding 10 can be substantially localized in one part in the circumferential direction, and the coils 21 and 22 of the second stator winding 20 can be substantially localized in another part in the circumferential direction. That is, the first stator winding 10 and the second stator winding 20 are unevenly distributed to opposite parts in the circumferential direction to reduce the number of coils 11 and 12 or coils 21 and 22 of one of the stator windings overlapping with the coils 21 and 22 or the coils 11 and 12 of the other stator winding. When the number of pole pairs is odd, the coils 11 and 12 of the first stator winding 10 cannot be completely separated from the coils 21 and 22 of the second stator winding 20. In FIG. 2, regions in which the coils 11 and 12 of the first stator winding 10 overlap with the coils 21 and 22 of the second stator winding 20 are surrounded by a dot-and-dash line.

Suppose the number of pole pairs is (2n+1) where n is a positive integer, the first stator winding 10 has (n+1) right-handed coils 11 for each phase, i.e., (3n+3) coils in total, and n left-handed coils 12 for each phase, i.e., 3n coils in total. The second stator winding 20 has n right-handed coils 21 for each phase, i.e., 3n coils in total, and (n+1) left-handed coils 22, i.e., (3n+3) coils in total. That is, the first stator winding 10 has (3n+1) right-handed coils 11 and 3n left-handed coils 12 that are alternately arranged in the center, and one more right-handed coil 11 arranged apart from each end of the set of alternately arranged coils. One left-handed coil 22 of the second stator winding 20 is sandwiched between each pair of the one right-handed coil 11 and the right-handed coil 11 at the end. The second stator winding 20 has (3n+1) left-handed coils 22 and 3n right-handed coils 21 that are alternately arranged in the center, and one more left-handed coil 22 arranged apart from each end of the set of alternately arranged coils. One right-handed coil 11 of the first stator winding 10 is sandwiched between each pair of the one left-handed coil 22 and the left-handed coil 22 at the end.

Specifically, the right-handed coil 11U of the first stator winding 10 at the first position in a phase rotation direction is arranged apart from the other coils 11 and 12 of the first stator winding 10 with the left-handed coil 22W of the second stator winding 20 at the last position in the phase rotation direction sandwiched between the right-handed coil 11U and the other coils 11 and 12. The right-handed coil 11W at the last position in the phase rotation direction of the first stator winding 10 is arranged apart from the other coils 11 and 12 of the first stator winding 10 with the left-handed coil 22U of the second stator winding 20 at the first position in the phase rotation direction sandwiched between the right-handed coil 11W and the other coils 11 and 12. Conversely, the left-handed coil 22U of the second stator winding 20 at the first position in the phase rotation direction is arranged apart from the other coils 21 and 22 of the second stator winding 20 with the right-handed coil 11W of the first stator winding 10 at the last position in the phase rotation direction sandwiched between the left-handed coil 22U and the other coils 21 and 22. The left-handed coil 22W of the second stator winding 20 at the last position in the phase rotation direction is arranged apart from the other coils 21 and 22 of the second stator winding 20 with the right-handed coil 11U of the first stator winding 10 at the first position in the phase rotation direction sandwiched between the left-handed coil 22W and the other coils 21 and 22.

Suppose the number of pole pairs is 2n, the first stator winding 10 has n right-handed coils 11 for each phase and n left-handed coils 12 for each phase that are alternately arranged with the right-handed coils 11. The second stator winding 20 has n right-handed coils 21 for each phase and n left-handed coils 22 for each phase that are alternately arranged with the right-handed coils. In the first stator winding 10 or the second stator winding, the U-phase right-handed coil 11U or 21U, the W-phase left-handed coil 12W or 22W, the V-phase right-handed coil 11V or 21V, the U-phase left-handed coil 12U or 22U, the W-phase right-handed coil 11W or 21W, and the V-phase left-handed coil 12V or 22V are repeatedly arranged in this order n times.

The motor 1 further includes a core (an iron core) 40 having a plurality of slots 41. In the present embodiment, the first stator winding 10 and the second stator winding are arranged in 36 slots 41 formed in the core 40. In FIGS. 3 to 5, the wires of the coils 11, 12, 21, and 22 are given with the numbers of the slots 41 in which the wires are arranged.

The first stator winding 10 and the second stator winding 20 are configured to reduce the number of slots 41 in which the coil 11, 12, 21, or 22 is arranged together with the coil of a different system so that the number of coils 11 and 12 or coils 21 and 22 overlapping with the coils 21 and 22 or the coils 11 and 12 of the different system is reduced.

As described above, the motor 1 includes the first stator winding 10 and the second stator winding 20. The first stator winding 10 includes a plurality of right-handed coils 11 and a plurality of left-handed coils 12 that are alternately arranged, and the center of the third-phase left-handed coil 12W is located between the center of the first-phase right-handed coil 11U and the center of the second-phase right-handed coil 11V. The second stator winding 20 includes a plurality of right-handed coils 21 and a plurality of left-handed coils 22 that are alternately arranged, and the center of the third-phase left-handed coil 22W is located between the center of the first-phase right-handed coil 21U and the center of the second-phase right-handed coil 21V. Thus, except for some coils, the coils 11 and 12 of the first stator winding 10 are collectively arranged, and the coils 21 and 22 of the second stator winding 20 are collectively arranged. In this motor 1, the first stator winding 10 and the second stator winding 20 overlap less with each other, causing less magnetic interference. This can increase the gain, i.e., the current value, even when the two inverters I1 and I2 have a large phase difference. Thus, the motor 1 can change the rotational speed in a short time, improving control response.

Especially, when the motor 1 has an odd number of pole pairs, the first stator winding 10 has three more right-handed coils 11 than the left-handed coils 12, and the second stator winding 20 has three less right-handed coils 21 than the left-handed coils 22. Thus, the first stator winding 10 and the second stator winding 20 can be equivalent, and the three phases of each stator winding can be symmetric.

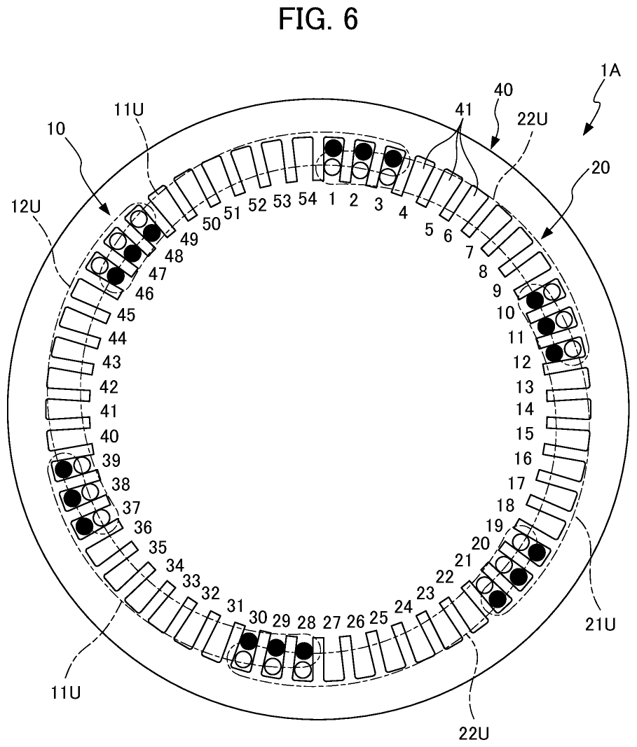

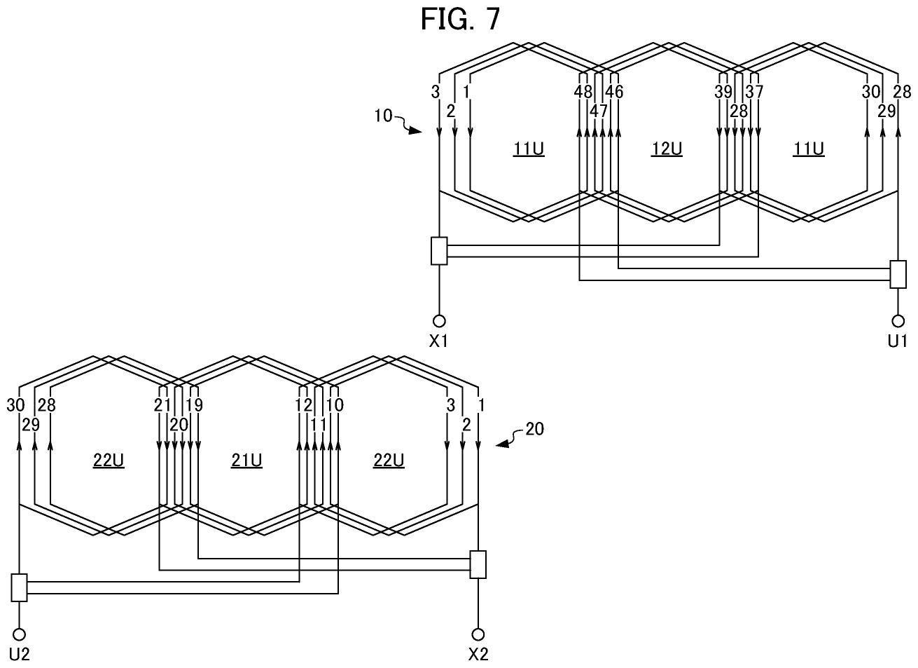

Referring to FIGS. 6 to 9, a motor 1A of a second embodiment of the present disclosure will be described below. The motor 1A of FIGS. 6 to 9 can be used for the drive system of FIG. 1 in place of the motor 1 of FIG. 2. For the motor 1A of FIGS. 6 to 9, like reference characters designate identical or corresponding components of the motor 1 of FIG. 2, and description of components designated by like reference characters may not be repeated. For the sake of simplicity, FIG. 6 shows the first phase (U-phase) coils only. Black dots indicate the wires of the right-handed coils, and white dots indicate the wires of the left-handed coils. Each coil is surrounded by a dot-and-dash line for discrimination. FIGS. 7, 8, and 9 separately show the first phase (U-phase) coils, the second phase (V-phase) coils, and the third phase (W-phase) coils.

The motor 1A includes a first stator winding 10 and a second stator winding 20 that receive three-phase alternating voltages applied from different inverters, and a core 40 having 54 slots 41 in which the first stator winding 10 and the second stator winding 20 are arranged. Numbers 1 to 54 that are consecutive in the circumferential direction are given to the slots 41 for discrimination.

Each of the first stator winding 10 and the second stator winding 20 has a plurality of right-handed coils and a plurality of left-handed coils that are alternately arranged.

The first stator winding 10 has a plurality of right-handed coils 11 and a plurality of left-handed coils 12. The second stator winding 20 has a plurality of right-handed coils 21 and a plurality of left-handed coils 22. The coils 11, 12, 21, and 22 are separately arranged in the slots 41. In FIGS. 7 to 9, the wires of the coils 11, 12, 21, and 22 are given with the numbers of the slots 41 in which the wires are arranged.

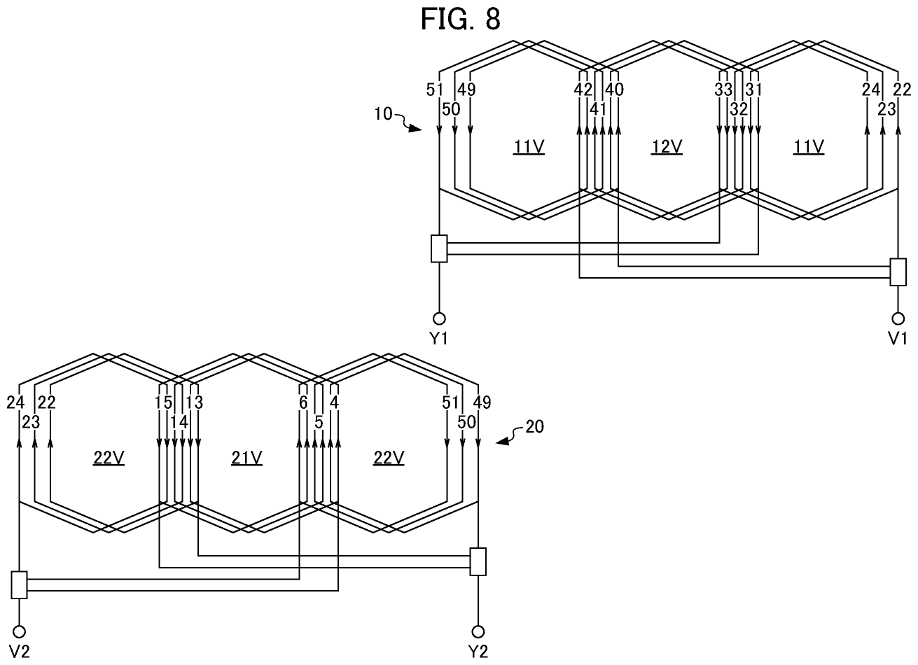

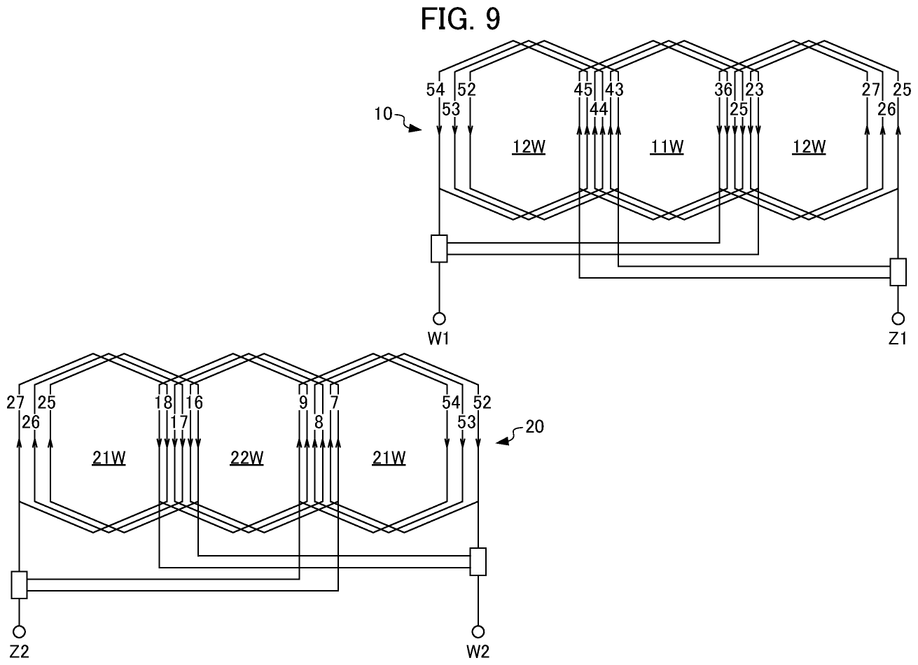

The positions of the slots 41 in which the coils 11, 12, 21, and 22 of the V-phase of FIG. 8, the W-phase of FIG. 9, and the U-phase of FIG. 6 are arranged are shifted in this order by three. Note that the input and output at the external terminals of the U-phase and V-phase coils and the input and output at the external terminal of the W-phase coils are reversed. Thus, the right-handed coils 11 and 21 and the left-handed coils 12 and 22 of the U-phase and V-phase are arranged in a reverse order of those of the W-phase. Thus, in each of the first stator winding 10 and the second stator winding 20, the center of the third-phase left-handed coil 12W or 22W is located between the center of the U-phase right-handed coil 11U or 21U and the center of the second-phase right-handed coil 11U or 21U.

In the motor 1A of the present embodiment, the first stator winding 10 and the second stator winding 20 are unevenly distributed in the circumferential direction to reduce the number of coils 11 and 12 or coils 21 and 22 of one of the stator windings overlapping with the coils 21 and 22 or the coils 11 and 12 of the other stator winding. This can reduce the interference between the systems, i.e., the interference between the magnetic field produced by the first stator winding 10 and the magnetic field produced by the second stator winding 20.

Embodiments of the motor of the present disclosure have just been described above, but the motor of the present disclosure is not limited to those exemplary embodiments. The advantages described in the embodiments are merely listed as the most preferable advantages derived from the motor of the present disclosure, and do not limit the advantages of the motor of the present disclosure.

It has been described in the embodiments that the U-phase is the first phase. However, the V-phase or the W-phase may be read as the first phase. The motor of the present disclosure may have any number of pole pairs.

### EXPLANATION OF REFERENCE NUMERALS

1, 1A Motor
10 First stator winding
11 Right-handed coil
21 Right-handed coil
20 Second stator winding
12 Left-handed coil
22 Left-handed coil
40 Core
41 Slot
I1, I2 Inverter

1. A motor that is a three-phase AC motor, comprising: two stator windings of different systems that receive voltages applied from different inverters, each of the stator windings having a plurality of coils, wherein
the stator windings are unevenly distributed in a circumferential direction to reduce the number of coils of one of the stator windings overlapping with the coils of the other stator winding.

2. The motor of claim 1, further comprising a core having a plurality of slots that arrange the coils, wherein
the stator windings are configured to reduce the number of slots in which the coils of different stator windings are arranged together.
